(19) United States
(12) Patent Application Publication
(10) Pub. No.: US 2026/0139385 A1
(43) Pub. Date: May 21, 2026

(54) ELECTROCHEMICAL CELL SYSTEM WITH THERMAL ENERGY STORAGE AND RELATIVE METHOD

(71) Applicant: NUOVO PIGNONE TECNOLOGIE -S.R.L., Florence (IT)

(72) Inventors: Martina TRINI, Florence (IT); Maurizio VACCARO, Florence (IT); Andrea BURRATO, Florence (IT); Simone CORBO, Florence (IT)

(21) Appl. No.: 19/121,690

(22) PCT Filed: Oct. 16, 2023
(86) PCT No.: PCT/EP2023/025435

§ 371 Date: Apr. 16, 2025

(30) Foreign Application Priority Data
Oct. 21, 2022 (IT) 102022000021747
Feb. 2, 2023 (IT) 102023000001728

(51) Int. Cl. C25B 1/042; C25B 9/67; C25B 9/70; C25B 15/021; C25B 15/08; H01M 8/04007; H01M 8/04014; H01M 8/04029; H01M 8/12

(52) U.S. Cl. CPC C25B 1/042; C25B 9/67; C25B 9/70; C25B 15/021; C25B 15/08; H01M 8/04014; H01M 8/04029; H01M 8/04052; H01M 2008/1293

(57) ABSTRACT

An electrochemical cell system which comprises an electrochemical cells arrangement, a control unit configured to operate the electrochemical cells arrangement only as electrolytic cells or only as fuel cells, a heat unit, external to the electrochemical cells arrangement, which is thermally coupled to the electrochemical cells arrangement and which is configured to alternately store heat from the electrochemical cells arrangement to the heat unit and supply heat from the heat unit to the electrochemical cells arrangement, and a transfer arrangement configured to alternately transfer heat from the electrochemical cells arrangement to the heat unit and from the heat unit to the electrochemical cells arrangement.

### TECHNICAL FIELD

The subject-matter disclosed herein relates to an electrochemical cell system with thermal energy storage and method for transfer heat between electrochemical cells and thermal energy storage.

### BACKGROUND ART

An electrochemical cell is a device capable of either generating electrical energy from chemical reactions or using electrical energy to cause chemical reactions. Typically, electrochemical cells processing chemicals or fuels for energy purposes (i.e. fuel cells) and electrochemical cells using energy for water decomposition purposes (i.e. electrolyzers) comprise at least three main components, which are set in a layer structure, represented by the two electrodes and an electrolyte in between.

Different types of electrochemical cells are currently known and may be classified for example by their operating temperature (high temperature cells, mid temperature cells and low temperature cells). For example, Solid Oxide Cells (SOCs) belong to high temperature cells and operate in a temperature range of typically 500-1000° C.; Proton conducting Ceramic Cells (PCCs) operate in a temperature range of typically 400° C.-700° C. As already stated above, electrochemical cells may operate for generating electrical energy (i.e. as fuel cells) or may use electrical energy to cause chemical reactions (i.e. as electrolyzers). For example, solid oxide electrolyzers use electrical energy to split water (=W) in order to generate hydrogen (=H2) and oxygen (=O2), while solid oxide fuel cells use a fuel (typically hydrogen or a fluid comprising a high percentage of hydrogen) and an oxidant, typically oxygen, to generate electrical energy (=EE) and steam (possibly also other exhaust streams).

It is to be noted that typically the electrolysis reaction is an endothermic reaction, therefore requiring thermal energy, while fuel cells typically work with an exothermic process, in particular an exothermic reaction, therefore generating energy. However, high temperature cells and mid temperature cells need higher temperature to operate with respect to the normal low temperature cells conditions (e.g. above 500 ° C.). For example, due to its higher operating temperatures, solid oxide electrolyzers can work in three different electrolysis modes: endothermic, thermoneutral or exothermic. However, after shutting down of the cells, the temperature of the cells is going to decrease and may even reach room temperature. Therefore, transient time of the cells, for example during start-up, may be long, e.g. it may take hours to reach the operating temperature.

There are known regenerative solid oxide cells, i.e. cells which can work reversibly as electrolyzers and fuel cells (see for example patent documents US 2016/0248137A1, US 2013/112569 A1 and US 2004/081859 A1). In particular, in regenerative solid oxide cells excess heat can be stored during the exothermic fuel cell mode and discharged heat during the endothermic electrolysis mode in order to help to maintain the reaction zone of cells at operating temperature. From report “Optimization & Demonstration of a Solid Oxide Regenerative Fuel Cell System” prepared for the United States Department of Energy National Energy Technology Laboratory, it is known to perform the storage of heat internally to a regenerative solid oxide cell, in particular by using phase change materials (=PCM) integrated into cell stacks in order to perform heat storage inside the regenerative solid oxide cells. From the article “Improving Hybrid Efficiency and Flexibility by Integrating Thermal Energy Storage into the Fuel Cell System” of Tucker et al., it is known to perform the storage of heat internally to a solid oxide cell, in particular by using the interconnect material, typically stainless steel, as thermal energy storage. The purpose of the internal heat storage and exchange in the cells is to provide the heat necessary for maintaining the reaction zone at operating temperature during electrolysis and it strongly depends on the operating state of the cells, as it works only when cells are operative (i.e. ON).

### SUMMARY

It would be desirable to have an electrochemical cell system which has a plurality of cells optimized to work only as an electrolyzer or only as fuel cell and which has a faster start-up time, in particular which can raise up the temperature of the cells before the next start-up so that at the start-up the temperature in the cells is substantially the operating temperature of the cells, improving cells performances. Moreover, it would be desirable to have an electrochemical cell system comprising a heat unit which can operate independently of the operation of the system, i.e. can exchange heat with the cells both when the cells are operative (i.e. ON) and when the cells are not operative (i.e. OFF).

According to an aspect, the subject-matter disclosed herein relates to a system of electrochemical cells which comprises an electrochemical cells arrangement, a control unit configured to operate the electrochemical cells arrangement only as electrolytic cells or only as fuel cells, a heat unit external to the electrochemical cells arrangement, which is thermally coupled to the electrochemical cells arrangement and which is configured to alternately store heat from the electrochemical cells arrangement to the heat unit and supply heat from the heat unit to the electrochemical cells arrangement, and a transfer arrangement configured to alternately transfer heat from the electrochemical cells arrangement to the heat unit and from the heat unit to the electrochemical cells arrangement.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 shows a simplified diagram of a first general embodiment of an innovative electrochemical cell system,

FIG. 2 shows a simplified diagram of the embodiment of FIG. 1 when operates as electrolytic cells during a charging phase of the heat unit,

FIG. 3 shows a simplified diagram of the embodiment of FIG. 1 when operates as fuel cells during a charging phase of the heat unit,

FIG. 4 shows a simplified diagram of a second embodiment of an innovative electrochemical cell system with a steam generation system during a discharge phase of the heat unit, and

FIG. 5 shows a simplified diagram of a third embodiment of an innovative electrochemical cell system with an external energy source during a discharge phase of the heat unit.

### DETAILED DESCRIPTION OF EMBODIMENTS

According to an aspect, the subject-matter disclosed herein relates to an electrochemical cell system which, when electrochemical cells are in operation, consumes at least electrical energy and water to generate at least hydrogen (=H2) or consumes at least a fuel comprising hydrogen (=H2) and an oxidant to generate at least electrical energy and which is provided with a thermal storage (external to the electrochemical cells) adapted to transfer heat to and from the electrochemical cells to reduce the start-up time of the cells and therefore being adapted to follow variable loads, such as renewable energy systems. The thermal storage may be charged (i.e. the thermal storage receives and stores heat) when the electrochemical cells are in operation and may be discharged (i.e. the thermal storage provide heat to the electrochemical cells) when electrochemical cells are not in operation. Advantageously, the innovative electrochemical cell system may use the thermal storage to keep the electrochemical cells hot, preferably at operating temperature, or to raise up the cells temperature before the operation of the cells, in order to reduce the start-up time of the cells. The heat transfer between the electrochemical cells and the thermal storage may be carried out by conduction and/or convection and/or irradiation through suitable means.

According to another aspect, the subject-matter disclosed herein relates to a method for transfer heat between electrochemical cells and a thermal storage which is external to the electrochemical cells and which can be charged and discharged independently from the operating mode of the electrochemical cells.

It is to be noted that, for the purpose of the present disclosure, the “electrochemical cell system” is a system comprising electrochemical cells which may process chemicals or fuels for energy purposes (i.e. fuel cells) or use energy for water decomposition purposes (i.e. electrolyzers). In particular, as it will better explain in the following, when the electrochemical cell system is configured to operate as an electrolyzer, it may perform electrolysis of water, in particular steam, to produce at least hydrogen, or it may perform co-electrolysis of CO2 and water, in particular steam, to produce at least a synthesis gas comprising hydrogen. For example, the electrochemical cell system may comprise solid oxide cells (=SOC) or proton conducting ceramic cells (=PCC). However, other type of cells may be used, in particular high temperature cells or mid temperature cells, for example cells which have an operative temperature higher than 100° C., preferably higher than 200° C.

Reference now will be made in detail to embodiments of the disclosure, examples of which are illustrated in the drawings. The examples and drawing figures are provided by way of explanation of the disclosure and should not be construed as a limitation of the disclosure. In fact, it will be apparent to those skilled in the art that various modifications and variations can be made in the present disclosure without departing from the scope or spirit of the disclosure. In the following description, similar reference numerals are used for the illustration of figures of the embodiments to indicate elements performing the same or similar functions. Moreover, for clarity of illustration, some references may be not repeated in all the figures.

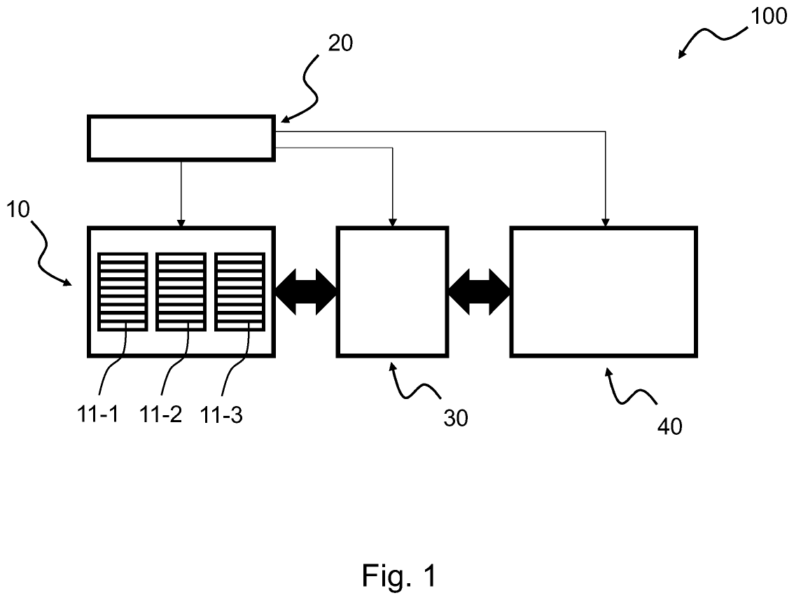

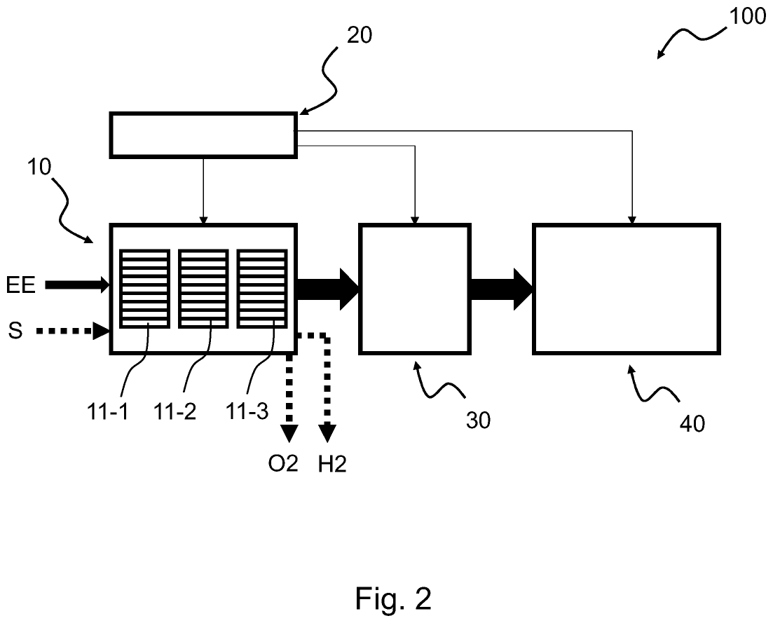

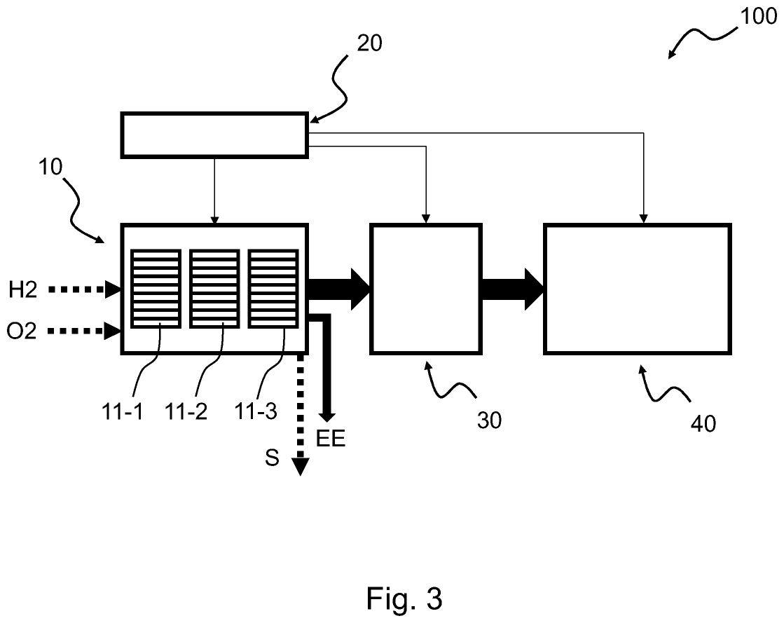

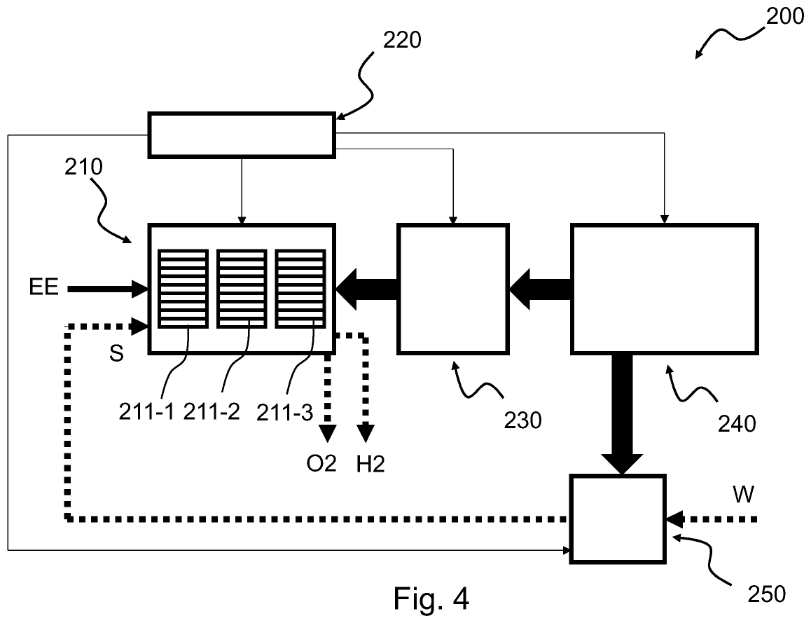

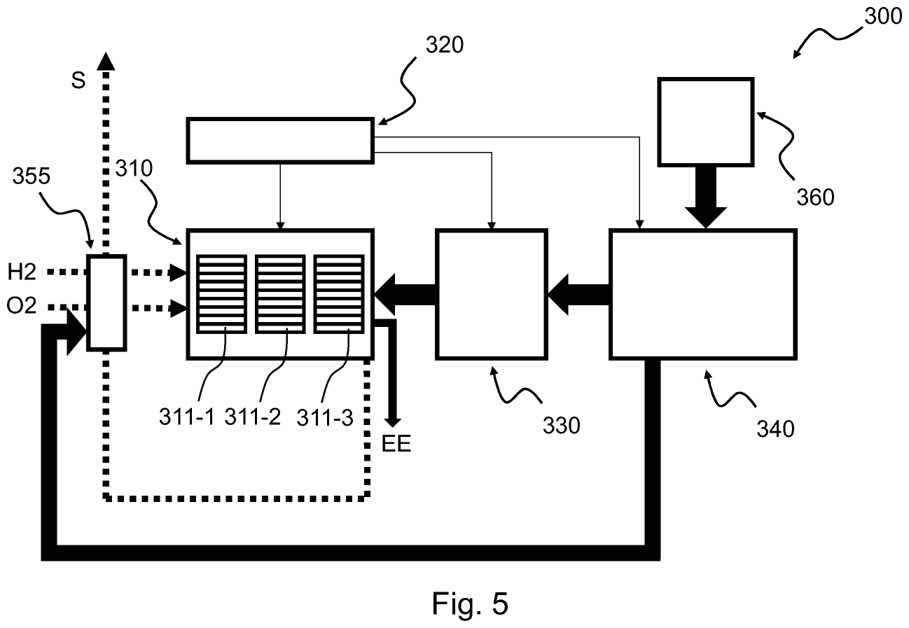

FIG. 1 shows a simplified diagram of a first embodiment of an innovative electrochemical cell system 100, referred in the following as “electrochemical cell system 100″ or simply ”system 100″. FIG. 2 and FIG. 3 shows respectively the first embodiment of the innovative electrochemical cell system 100 operating as electrolytic cells during a charging phase of the heat unit and the first embodiment of the innovative electrochemical cell system 100 operating as fuel cells during a charging phase of the heat unit. A second and a third embodiment of an innovative electrochemical cell system 200 and 300 will be described in the following with the aid of FIGS. 4 and 5.

With non-limiting reference to FIG. 1, the system 100 includes an electrochemical cells arrangement 10 comprising a plurality of electrochemical cells; typically, each electrochemical cell is in form of a stack 11 and all the electrochemical cells are electrically coupled to each other. In particular, the figure shows three electrochemical stacks 11-1, 11-2 and 11-3 comprising a plurality of cells; however, any number of electrochemical cells and stacks may be considered. Advantageously, the electrochemical cells arrangement 10 comprises mid-temperature cells or high-temperature cells; according to a possibility, the electrochemical cells arrangement 20 comprises a plurality of solid oxide cells (=SOCs).

Advantageously, each cell of the electrochemical cells arrangement comprises a semiconductor material in an anode and/or cathode and/or electrolyte of the cell. In particular, the anode and/or the cathode and/or the electrolyte may be or may include a n-type or a p-type semiconductor layer.

Advantageously, the cells of the electrochemical cells arrangement are in a solid state at least at room temperature. In particular, if solid oxide cells (=SOCs) or proton conducting ceramic cells (=PCCs) are used, the cells of the electrochemical cells arrangement are in a solid state both at room temperature and operating temperature.

Advantageously, the electrolyte of the electrochemical cells arrangement is permeable to ions at least at operating temperature. For example, if solid oxide cells (=SOCs) are used, the electrolyte is permeable to ions O⁻, while if proton conducting ceramic cells (=PCCs) are used, the electrolyte is permeable to ions H⁺. However, as stated above, others type of cells may be used, in particular mid-temperature cells or high-temperature cells.

It is to be noted that the electrochemical cell system may work in two different modes: as an electrolytic cell or as a fuel cell. In other words, the electrochemical cells arrangement is not configured to switch between an operating mode as electrolytic cells and an operating mode as fuel cells, but only between an operating mode (in which the electrochemical cells work as electrolytic cells or as fuel cells) and a non-operating mode (in which the electrochemical cells are not working). When an electrochemical cell system operates in electrolytic cell mode, the system consumes at least electrical energy and steam to generate at least hydrogen, whereas when it operates in fuel cell mode, the system consumes at least hydrogen (or any suitable fuels comprising hydrogen, for example methane) and an oxidant, for example air, to generate at least electrical energy.

The system 100 further comprises a control unit 20 which is configured to operate the electrochemical cells arrangement 10 only as electrolytic cells or only as fuel cells. As a nonlimiting example, the control unit 10 could be a computer, programmable controller, microprocessor or similar device. As it will better explained in the following, the control unit 20 may be programmed for example to operate the electrochemical cells arrangement 10 according to a predetermined time schedule and/or a predetermined operating mode. As it will better explained in the following, the control unit 20 may be configured to operate and possibly control other elements of the system 100.

According to an embodiment, in particular when the electrochemical cells arrangement 10 operates as electrolytic cells (see for example FIG. 2), the electrochemical cells arrangement 10 is configured to receive at least electrical energy (=EE) from an external energy source, advantageously a renewable energy source, for example a solar power plant or a wind power plant. Considering that in general renewable electricity generation from renewable energy sources is variable and/or intermittent, for example may depend on the amount of sunlight at a given place and time or on wind speeds, air density, and turbine characteristics (among other factors), also the electrochemical cells arrangement 10 may be configured to operate intermittently.

According to another embodiment, in particular when electrochemical cells arrangement 10 operates as fuel cells (see for example FIG. 3), the electrochemical cells arrangement 10 may be configured to produce electrical energy (=EE) starting at least from hydrogen or a suitable fuel comprising hydrogen, for example methane. Considering that in general the electrical energy demand is not constant over time (i.e. it is intermittent and/or has variable load profile), also the electrochemical cells arrangement 10 may be configured to operate intermittently.

Advantageously, the control unit 20 may be programmed to control the electrochemical cells arrangement 10 according to a predetermined strategy. For example, if the electrochemical cells arrangement 10 receives electrical energy from a solar power plant, the control unit 20 may control the electrochemical cells arrangement operation based on the time when the sun rises and sets: according to an example, the electrochemical cells arrangement 10 may be turned on at 8:00 and turned off at 18:00. However, since electrochemical cell typically have high operating temperatures, for example higher than 500° C., the electrochemical cells arrangement 10 takes time after the switching on to reach the operating temperature (the so-called “start-up time”), reducing thus the performances of the system.

The system 100 further comprises a heat unit 40 external to the electrochemical cells arrangement 10 which is thermally coupled to the electrochemical cells arrangement 10 and which is configured to alternately store heat from the electrochemical cells arrangement 10 to the heat unit 40 and supply heat from the heat unit 40 to the electrochemical cells arrangement 10. As a nonlimiting example, the heat unit 40 could be a thermal storage tank using a thermal storage medium (for example molten salts, phase change materials, metal mixtures or similar) or similar device for storing thermal energy. In particular, and as it will be better explained in the following, the heat unit 40 can store heat (charging phase) from the electrochemical cells arrangement 10 and possibly from an external energy source (see for example the external energy source 360 in FIG. 5) and supply heat (discharging phase) to the electrochemical cells arrangement 10 independently from the operating mode of the electrochemical cells arrangement 10. In particular, the heat unit 40 can store heat and supply heat both if the electrochemical cells arrangement 10 is operating (i.e. is on) and if the electrochemical cells arrangement 10 is not operating (i.e. is off) and/or the heat unit 40 can store heat and supply heat both if the electrochemical cells arrangement 10 is operating as electrolytic cells and if the electrochemical cells arrangement 10 is operating as fuel cells.

According to a possibility, the heat unit 40 can store heat when the electrochemical cells arrangement 10 is operating, for example, with non-limiting reference to the previous example, between 8:00 and 18:00, in particular during the whole operating time or during one or more time intervals of the operating time. According to a possibility, the heat unit 40 can supply heat to the electrochemical cells arrangement 10 when the electrochemical cells arrangement 10 is not operating, for example, with non-limiting reference to the previous example, between 18:00 and 8:00. Advantageously, the heat unit 40 is configured to supply heat to the electrochemical cells arrangement 10 just before the turning on of the electrochemical cells arrangement 10, for example from 6:00 to 8:00 or, in general, in a suitable time interval in order to heat up the electrochemical cells arrangement 10 so as to reach the operating temperature of electrochemical cells at the turning on time.

Advantageously, the control unit 20 is further configured to control operation of the heat unit 40. In particular, the control unit 20 may be configured to control the amount of heat stored in the heat unit 40, e.g. the state of charge/discharge of the heat unit 40. Advantageously, the heat unit 40 is arranged around the electrochemical cells arrangement 10. More advantageously, the electrochemical cell system further comprises an insulating enclosure which is arranged around the heat unit 40.

The electrochemical cell system 100 further comprises a transfer arrangement 30 which is configured to alternately transfer heat from the electrochemical cells arrangement 10 to the heat unit 40 and from the heat unit 40 to the electrochemical cells arrangement 10. As it will better explained in the following, the transfer arrangement 30 is configured to transfer heat by conduction and/or convection and/or irradiation. Advantageously, the control unit 20 is further configured to operate the transfer arrangement 30 so to alternatively turn on and turn off the transfer arrangement 30. In particular, when the transfer arrangement 30 is turned on, the heat transfer between the heat unit 40 and the electrochemical cells arrangement 30 is permitted; in other words, when the transfer arrangement 30 is turned on, the heat unit 40 can store or supply energy from or to the electrochemical cells arrangement 30.

In order to transfer heat by conduction, the transfer arrangement 30 advantageously comprises a solid device which is mechanically coupled to the electrochemical cells arrangement 10 and the heat unit 40 and which is configured to transfer heat by conduction between electrochemical cells arrangement 10 and the heat unit 40. According to a possibility, the electrochemical may be in the form of one or more rods or plates; advantageously, the solid device is a plurality of rods or plates. When the charging/discharging phase of the heat unit 40 is needed, the solid device is in contact with the electrochemical cells arrangement 10, in particular may be located between each electrochemical cell, in order to transfer heat between the heat unit 40 and the electrochemical cells arrangement 10. Alternatively, when there is no need of exchanging heat between the heat unit 40 and the electrochemical cells arrangement 10, the solid device is moved away in such a way as to avoid contact with the electrochemical cells arrangement 10 and avoid the heat exchange. Advantageously, the control unit 20 may regulate the position of the solid device. More advantageously, the position of each rod or plate may be regulated independently, in order to allow a finer regulation of the heat amount transferred between the heat unit 40 and the electrochemical cells arrangement 10.

In order to transfer heat by convection, the transfer arrangement 30 advantageously comprises a fluid circuit which is configured to circulate a fluid between the electrochemical cells arrangement 10 and the heat unit 40 and to transfer heat by convection between the electrochemical cells arrangement 10 and the heat unit 40. According to a possibility, the fluid is an inert gas (for example nitrogen or carbon dioxide or argon) or molten salts or changing phase material (=PCM) or liquid metal. Advantageously, the fluid circuit further comprises a mechanical operating machine (for example a fan or a pump) and possibly also a control valve, in order to regulate the amount of fluid circulating in the fluid circuit.

In order to transfer heat by irradiation, the transfer arrangement 30 advantageously comprises an emitting/absorbing layer which is arranged around the electrochemical cells arrangement 10 and is configured to selectively transfer heat by radiation (which may be emitted or absorbed) between the electrochemical cells arrangement 10 and the heat unit 40. It is to be noted that the emitting/absorbing layer can receive heat from the electrochemical cells arrangement 10 to the heat unit 40 (i.e. it works as an emitting layer during a charge phase of the heat unit 40) and can supply heat from the storage heat unit 40 to the electrochemical cells arrangement 10 (i.e. it works as an absorbing layer during a discharge phase of the heat unit 40). According to a possibility, the transfer arrangement 30 further comprises an insulating layer (or reflecting layer) in order to regulate of the heat amount transferred between the heat unit 40 and the electrochemical cells arrangement 10. Advantageously, the control unit 20 may regulate the position of the insulating layer so that, when the insulating layer is located totally or partially between the heat unit 40 and the electrochemical cells arrangement 10, the heat exchanging between them is totally or partially stopped.

As previously described, the electrochemical cells arrangement 10 can operate as electrolytic cells or as fuel cells. In FIG. 2 it is shown an electrochemical cell system 100 when operates as electrolytic cells, in particular during a charging phase of the heat unit 40. The electrochemical cells arrangement 10 has at least two inlets and two outlets; in particular, the electrochemical cells arrangement 10 is configured to receive as inputs at least electrical energy EE, preferably electrical energy from a renewable energy source, at a first inlet and steam S at a second inlet. The electrochemical cells arrangement 10 is configured to supply as outputs at least oxygen O2 at a first outlet and hydrogen H2 at a second outlet. According to another possibility, not shown in any figures, the electrochemical cells arrangement 10 is further configured to receive carbon dioxide CO2 as input at a third inlet and supply a synthesis gas comprising hydrogen as output at the second outlet. It is to be noted that other flue gases may possibly be generated by the electrochemical cells arrangement 10 depending for example on the purity of the inlet flows.

In FIG. 3 it is shown an electrochemical cell system 100 when operates as fuel cells, in particular during a charging phase of the heat unit 40. The electrochemical cells arrangement 10 has at least two inlets and two outlets; in particular, the electrochemical cells arrangement 10 is configured to receive as inputs at least oxygen O2 or air, in particular ambient air, at a first inlet and hydrogen H2 or a suitable fuel comprising hydrogen at a second inlet. It is to be noted that hydrogen H2 provided at the second inlet may be pure hydrogen (or substantially pure, for example with a purity of 95% or higher) or may be mixed with other substances, in particular carbon (for example it may be provided in the form of a hydrocarbon fuel, for example methane). The electrochemical cells arrangement 10 is configured to supply as outputs at least electrical energy EE at a first outlet and steam S at a second outlet. It is to be noted that other flue gas may possibly be generated by the electrochemical cells arrangement 10 depending for example on the purity of the hydrogen and/or on the oxidant used (oxygen or air).

A second embodiment 200 of an electrochemical cell system will be described in the following with the aid of FIG. 4. It is to be noted that elements 210, 211, 220, 230 and 240 in FIG. 4 may be identical or similar respectively to elements 10 (electrochemical cells arrangement), 11 (electrochemical cells stack), 20 (control unit), 30 (transfer arrangement) and 40 (heat unit) in FIG. 1 and perform the same or similar functions. It is also to be noted that the electrochemical cell system 200 of FIG. 4 is shown operating as electrolytic cells, in particular during a discharge phase of the heat unit 240, as it will be apparent from the following.

With non-limiting reference to FIG. 4, the electrochemical cell system 100 may further comprising a steam production generation system 250 which is configured to receive water W as input and to generate steam S as output. In particular, the steam generation system 250 is thermally coupled to the heat unit 240, so that the heat unit 240 may supply heat to the steam production generation system 250 to generate steam S.

Advantageously, the control unit 220 is further configured to control operation of the steam production generation system 250. In particular, the control unit 220 may be configured to control the amount of heat transferred from the heat unit 240 to the steam production generation system 250, e.g. to control the amount of steam S generated by the steam production generation system 250.

A third embodiment 300 of an electrochemical cell system will be described in the following with the aid of FIG. 5. It is to be noted that elements 310, 311, 320, 330 and 340 in FIG. 5 may be identical or similar respectively to elements 10 (electrochemical cells arrangement), 11 (electrochemical cells stack), 20 (control unit), 30 (transfer arrangement) and 40 (heat unit) in FIG. 1 and perform the same or similar functions. It is also to be noted that the electrochemical cell system 300 of FIG. 5 is shown operating as fuel cells, in particular during a discharge phase of the heat unit 340, as it will be apparent from the following.

With non-limiting reference to FIG. 5, the electrochemical cells arrangement 310 is configured to receive pre-heated inputs, in particular fuel and oxidant (for example hydrogen and oxygen) at a temperature much higher than ambient temperature. According to a possibility, the steam S generated by the electrochemical cells arrangement 310 as output is still at high temperature and its heat may be exploited to pre-heat inputs of the electrochemical cells arrangement 310. In particular, the flow of steam S may supply heat to the fuel and oxidant used as inputs of the electrochemical cells arrangement 310; for example, the electrochemical cell system 300 may include a dedicated heat exchanger 355 in which the heat exchange between steam S and inputs, in particular hydrogen H2 (or a suitable fuel comprising hydrogen) and oxygen O2, takes place. It is to be noted that the heat exchanger 355 may be external or integrated to the electrochemical cells arrangement 310. It is also to be noted that, after heat exchange, the steam S at the outlet of the heat exchanger 355 may be steam S at lower temperature or a mixture of steam S and water W or liquid water W.

Alternatively or in addiction, the heat unit 340 may further provide heat to pre-heat inputs received by the electrochemical cells arrangement 310. In particular, the heat unit 340 may be thermally coupled to the fuel and oxidant used as inputs of the electrochemical cells arrangement 310; for example, the heat unit may supply heat to the dedicated heat exchanger 355 in which the heat exchange takes place.

With non-limiting reference to FIG. 5, the electrochemical cells arrangement 310 further comprises an external energy source 360, in particular a waste heat source and/or a renewable energy source, which is thermally coupled to the heat unit 340. Advantageously, the external energy source 360 is configured to generate heat and, in particular, to provide heat to the heat unit 340. Advantageously, the heat unit 340 is configured to store the heat received from the external energy source.

According to another aspect, the subject matter disclosed herein relates to a method or transfer heat between an electrochemical cells arrangement 10 comprising a plurality of electrochemical cells and a heat unit 40 external to the electrochemical cells. The method comprising the steps of:
storing heat from the electrochemical cells arrangement 10 to the heat unit 40 during a charging phase of the heat unit 40,
supplying heat from the heat unit 40 to the electrochemical cells arrangement 10 during a discharging phase of the heat unit 40, and
controlling the operation of the electrochemical cells arrangement 10 through a control unit 20, the control unit 20 switching the electrochemical cells arrangement 10 between an operating mode and a non-operating mode.

It is to be noted that the operating mode of the electrochemical cells arrangement 10 is only as electrolytic cells or only as fuel cells; in other words, the electrochemical cells arrangement 10 is not configured to switch between an operating mode as electrolytic cells and an operating mode as fuel cells, but only between an operating mode (in which the electrochemical cells work as electrolytic cells or as fuel cells) and a non-operating mode (in which the electrochemical cells are not working).

It is also to be noted that the charging phase and the discharging phase of the heat unit 40 are performed independently from the operating mode of the electrochemical cells arrangement 10. In particular, the heat unit 40 may be charged and discharged both if the electrochemical cells arrangement 10 work as electrolytic cells and if the electrochemical cells work as fuel cell and/or if the electrochemical cells arrangement 10 is operating and if the electrochemical cells arrangement 10 is not operating.

It is also to be noted that the step of storing heat and the step of supplying heat is performed by conduction and/or convection and/or irradiation. Advantageously, the step of storing heat and the step of supplying heat is performed through a transfer arrangement 30 which is configured to alternately transfer heat (by conduction and/or convection and/or irradiation) from the electrochemical cells arrangement 10 to the heat unit 40 and from the heat unit 40 to the electrochemical cells arrangement 10. It is to be noted that the heat unit 40 may further storing heat from an external heat source, for example from a waste heat source or a renewable energy source.

1. An electrochemical cell system comprising:
an electrochemical cells arrangement comprising a plurality of cells, a control unit configured to operate the electrochemical cells arrangement only as electrolytic cells or only as fuel cells,
a heat unit which is thermally coupled to the electrochemical cells arrangement and which is configured to alternately store heat from the electrochemical cells arrangement to the heat unit and supply heat from the heat unit to the electrochemical cells arrangement; and,
a transfer arrangement 6 configured to alternately transfer heat from the electrochemical cells arrangement to the heat unit and from the heat unit to the electrochemical cells arrangement,
wherein the heat unit is external to the electrochemical cells arrangement,
wherein the transfer arrangement is configured to transfer heat by conduction and/or convection and/or irradiation.

2. The electrochemical cell system of claim 1, wherein each cell of the electrochemical cells arrangement comprises a semiconductor material in an anode and/or cathode and/or electrolyte of the cell.

3. The electrochemical cell system of claim 1, wherein the cells of the electrochemical cells arrangement are in a solid state at least at room temperature.

4. The electrochemical cell system of claim 2, wherein the electrolyte of the electrochemical cells arrangement is permeable to ions at least at cell operating temperature.

5. The electrochemical cell system of claim 1, wherein the control unit is further configured to operate the transfer arrangement so to alternatively turn on and turn off the transfer arrangement

6. The electrochemical cell system of claim 1, wherein the heat unit is arranged around the electrochemical cells arrangement

7. The electrochemical cell system of claim 1, further comprising an insulating enclosure which is arranged around the heat unit

8. The electrochemical cell system of claim 1, wherein the transfer arrangement comprises a solid device, the solid device being mechanically coupled to the electrochemical cells arrangement 9,240 and the heat unit wherein the solid device is configured to transfer heat by conduction between the electrochemical cells arrangement and the heat unit

9. The electrochemical cell system of claim 1, wherein the transfer arrangement (comprises a fluid circuit configured to circulate a fluid between the electrochemical cells arrangement and the heat unit wherein the fluid circuit is configured to transfer heat by convection between the electrochemical cells arrangement and the heat unit

10. The electrochemical cell system of claim 9, wherein the fluid is an inert gas or molten salts or changing phase material or liquid metal.

11. The electrochemical cell system of claim 1, wherein the transfer arrangement comprises an emitting/absorbing layer arranged around the electrochemical cells arrangement wherein the emitting/absorbing layer is selectively configured to transfer/receiving heat by radiation between the electrochemical cells arrangement and the heat unit

12. The electrochemical cell system of claim 1, wherein the electrochemical cells arrangement has at least two inlets and two outlets, wherein, when the electrochemical cells arrangement operates as electrolytic cells, the electrochemical cells arrangement is configured to receive at least electrical energy at a first inlet and steam(S) at a second inlet as inputs and to supply at least oxygen at a first outlet and hydrogen or a suitable synthesis gas comprising hydrogen at a second outlet as outputs, and wherein, when the electrochemical cells arrangement operates as fuel cells, the electrochemical cells arrangement is configured to receive at least oxygen or air at a first inlet and hydrogen or a suitable fuel comprising hydrogen at a second inlet as inputs and to supply at least electrical energy at a first outlet and a fluid comprising steam at a second outlet as outputs.

13. The electrochemical cell system of claim 1, further comprising an external energy source, in particular a waste heat source and/or a renewable energy source, thermally coupled to the heat unit wherein the external energy source is configured to generate heat, wherein the heat unit is configured to store heat from the external energy source

14. The electrochemical cell system of claim 1, further comprising a steam generation system thermally coupled to the heat unit wherein the steam generation system is configured to receive water as input and to generate steam as output, wherein the heat unit is configured to supply heat to the steam generation system to generate steam.

15. The electrochemical cell system of claim 14, wherein the steam generated by the steam generation system is supplied to the electrochemical cells arrangement.

16. The electrochemical cell system of claim 12, wherein the heat unit is thermally coupled to inputs of the electrochemical cells arrangement, wherein the heat unit is configured to supply heat to inputs received by the electrochemical cells arrangement in order to pre-heat inputs.

17. A method for transfer heat between an electrochemical cells arrangement comprising a plurality of cells and a heat unit external to the cells, the method comprising the steps of:
storing heat from the electrochemical cells arrangement to the heat unit during a charging phase of the heat unit,
supplying heat from the heat unit to the electrochemical cells arrangement during a discharging phase of the heat unit,
controlling the operation of the electrochemical cells arrangement through a control unit, the control unit switching the electrochemical cells arrangement between an operating mode and a non-operating mode, wherein the operating mode of the electrochemical cells arrangement is only as electrolytic cells or only as fuel cells, wherein the charging phase and the discharging phase of the heat unit are performed independently from the operating mode of the electrochemical cells arrangement, wherein the step of storing heat and the step of supplying heat is performed by conduction and/or convection and/or irradiation.

18. The method according to claim 17, wherein the step of storing heat and the step of supplying heat is performed through a transfer arrangement configured to alternately transfer heat from the electrochemical cells arrangement to the heat unit and from the heat unit to the electrochemical cells arrangement.
